(19) United States
(12) Patent Application Publication
(10) Pub. No.: US 2010/0091678 A1
(43) Pub. Date: Apr. 15, 2010

(54) DOWNLINK RANK INDICATION AND UPLINK RANK REPORTING FOR DEDICATED BEAMFORMING

(75) Inventors: Runhua Chen, Dallas, TX (US); Eko N. Onggosanusi, Allen, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/576,398

(22) Filed: Oct. 9, 2009

Related U.S. Application Data
(60) Provisional application No. 61/103,971, filed on Oct. 9, 2008.

(51) Int. Cl. H04L 12/26; H04L 27/28

(52) U.S. Cl. 370/252; 375/260

(57) ABSTRACT

A network transmitter and receiver are for use with a network MIMO super cell. The network transmitter includes a rank control unit configured to provide a rank indication for a dedicated beamforming transmission from the network MIMO super cell, wherein the rank indication corresponds to spatial multiplexing of multiple data streams for the dedicated beamforming transmission. The network transmitter also includes a transmission unit configured to signal the rank indication. The network receiver includes a reception unit configured to receive a dedicated beamforming transmission within the network MIMO super cell. The network receiver also includes a rank processing unit configured to process a rank indication for the dedicated beamforming transmission corresponding to spatial multiplexing of multiple data streams for the dedicated beamforming transmission.

### CROSS-REFERENCE TO RELATED APPLICATION

This application claims the benefit of U.S. Provisional Application Ser. No. 61/103,971, filed by Runhua Chen, et al. on Oct. 9, 2008, entitled “DOWNLINK RANK INDICATION AND UPLINK RANK REPORT FOR DEDICATED BEAMFORMING,” commonly assigned with this application and incorporated herein by reference.

### TECHNICAL FIELD

This application is directed, in general, to a communication system and, more specifically, to a network transmitter, a network receiver and methods of operating a network transmitter and a network receiver.

### BACKGROUND

In a cellular network, such as one employing orthogonal frequency division multiple access (OFDMA), each cell employs a base station that communicates with user equipment. MIMO communication systems offer large increases in throughput due to their ability to support multiple parallel data streams that are each transmitted from different antennas. These systems provide increased data rates and reliability by exploiting a spatial multiplexing gain or spatial diversity gain that is available to MIMO channels. Although current data rates are adequate, improvements in this area would prove beneficial in the art.

### SUMMARY

Embodiments of the present disclosure employ a network transmitter, a network receiver and methods of operating a network transmitter and a network receiver. In one embodiment, the network transmitter is for use with a network MIMO super cell and includes a rank control unit configured to provide a rank indication for a dedicated beamforming transmission from the network MIMO super cell, wherein the rank indication corresponds to spatial multiplexing of multiple data streams for the dedicated beamforming transmission. The network transmitter also includes a transmission unit configured to signal the rank indication.

In another embodiment, the network receiver is for use with a network MIMO super cell and includes a reception unit configured to receive a dedicated beamforming transmission within the network MIMO super cell. The network receiver also includes a rank processing unit configured to process a rank indication for the dedicated beamforming transmission, wherein the rank indication corresponds to spatial multiplexing of multiple data streams for the dedicated beamforming transmission.

In another aspect, the method of operating a network transmitter is for use with a network MIMO super cell and includes providing a rank indication for a dedicated beamforming transmission from the network MIMO super cell, wherein the rank indication corresponds to spatial multiplexing of multiple data streams for the dedicated beamforming transmission. The method also includes signaling the rank indication.

In yet another aspect, the method of operating a network receiver is for use with a network MIMO super cell and includes receiving a dedicated beamforming transmission within the network MIMO super cell. The method also includes processing a rank indication for the dedicated beamforming transmission, wherein the rank indication corresponds to spatial multiplexing of multiple data streams for the dedicated beamforming transmission.

The foregoing has outlined preferred and alternative features of the present disclosure so that those skilled in the art may better understand the detailed description of the disclosure that follows. Additional features of the disclosure will be described hereinafter that form the subject of the claims of the disclosure. Those skilled in the art will appreciate that they can readily use the disclosed conception and specific embodiment as a basis for designing or modifying other structures for carrying out the same purposes of the present disclosure.

### BRIEF DESCRIPTION

Reference is now made to the following descriptions taken in conjunction with the accompanying drawings, in which:

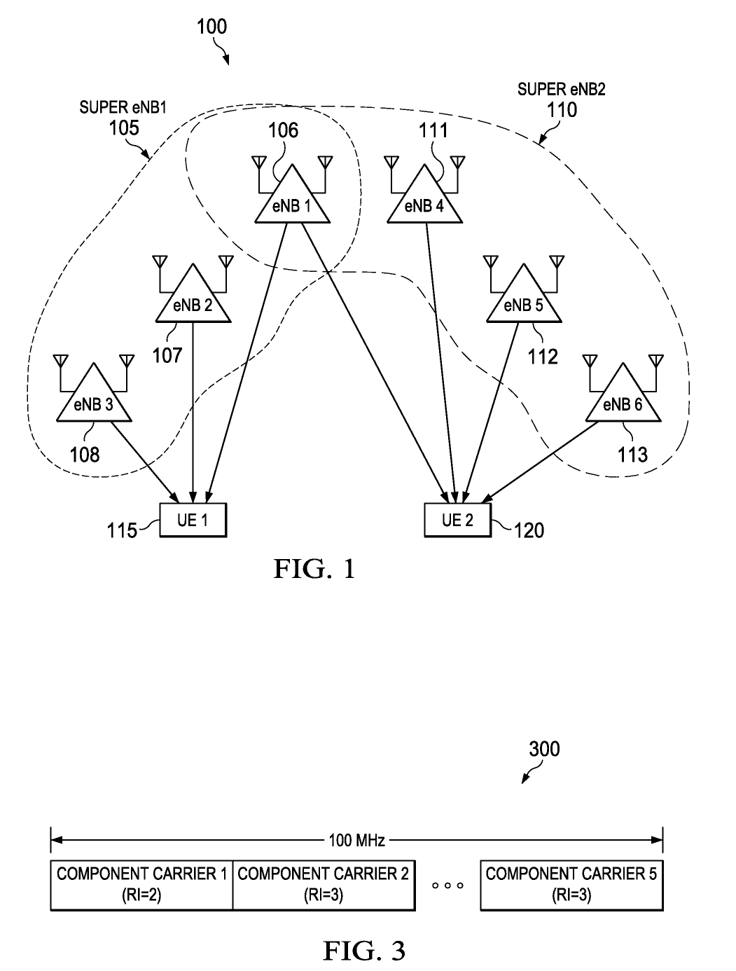

FIG. 1 illustrates a general example of a network MIMO constructed according to the principles of the present disclosure;

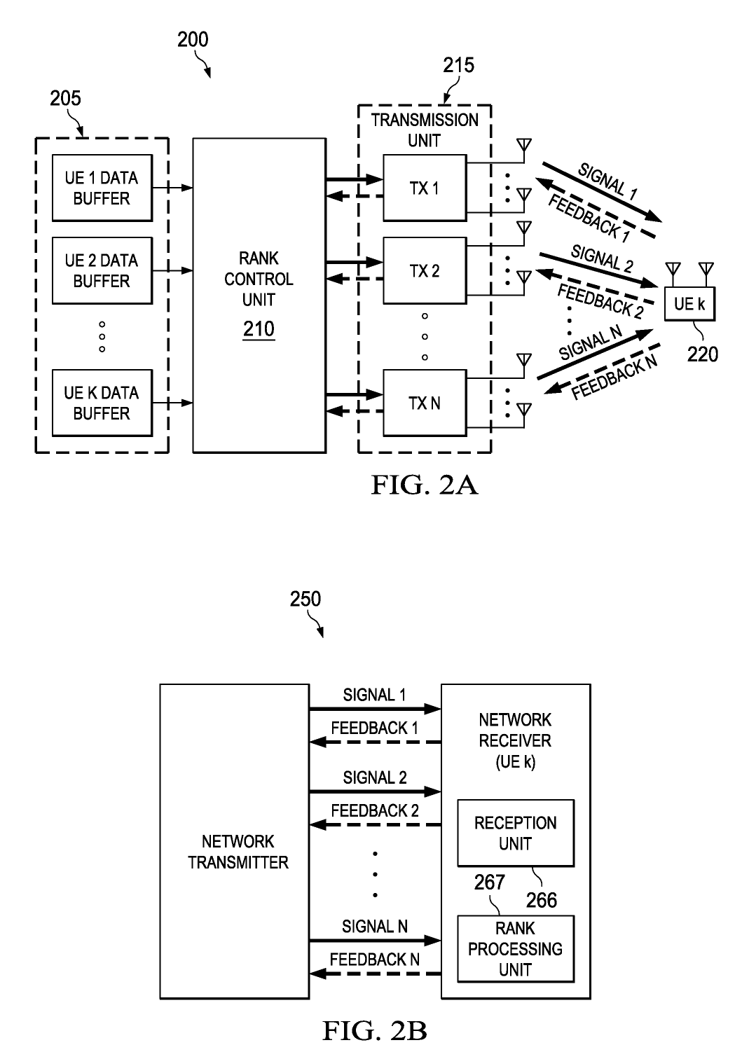

FIGS. 2A and 2B illustrate diagrams of a network transmitter as may be employed as a super eNB of a network MIMO super cell, and a network receiver as may be employed by user equipment in the network MIMO super cell;

FIG. 3 illustrates a diagram of a 100 MHz bandwidth as may be employed in an LTE-A system;

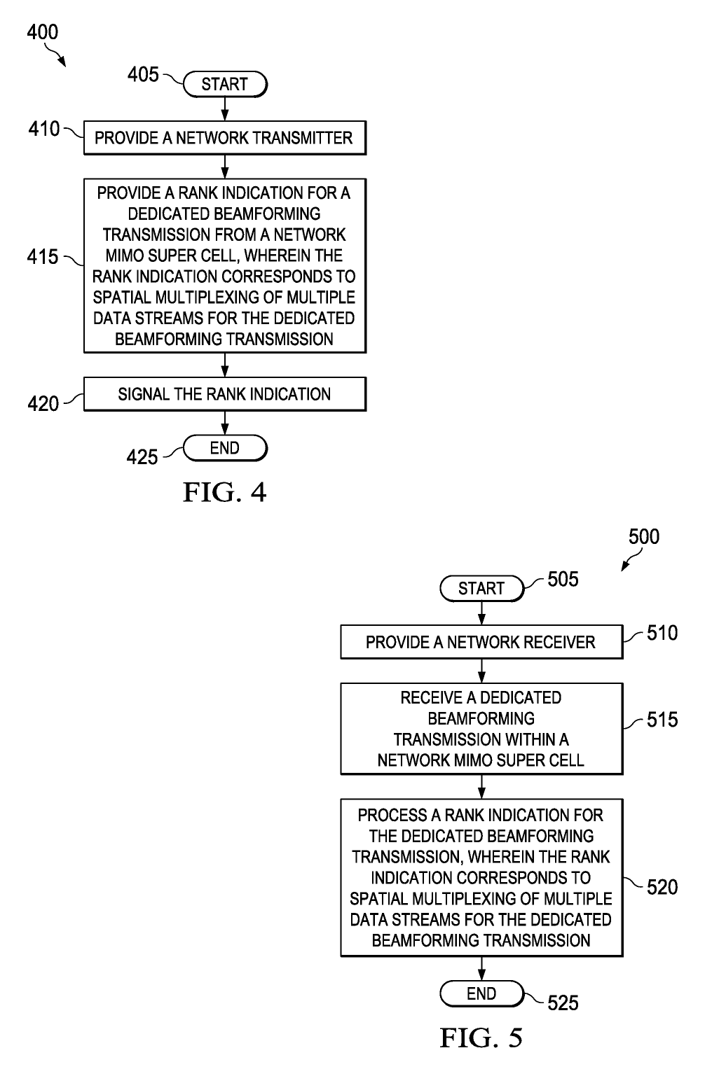

FIG. 4 illustrates a flow diagram of an embodiment of a method of operating a network transmitter carried out according to the principles of the present disclosure; and

FIG. 5 illustrates a flow diagram of an embodiment of a method of operating a network receiver carried out according to the principles of the present disclosure.

### DETAILED DESCRIPTION

The current LTE E-UTRA system supports non-codebook based precoding. A base station (eNB) operating within the LTE E-UTRA system can select a precoding matrix based on its knowledge of channel state information (CSI) and apply the precoding matrix in a PDSCH (physical downlink shared channel) data transmission. This is in contrast to codebook based precoding where the precoding matrix needs to be selected by user equipment (UE) from a pre-defined codebook and reported to the eNB. Current non-codebook based precoding in E-UTRA supports only a single-layer (rank-1) transmission (i.e., there is a single data stream in a PDSCH). From the UE perspective, this can be viewed as data that is transmitted from a single antenna port (i.e., antenna port 5) and defined as dedicated beamforming on antenna port 5 in E-UTRA.

A cell-specific reference symbol (CRS) on antenna ports 0-3 is not precoded and is used for control channel decoding (e.g., corresponding to a PCFICH (physical control format indicator channel), a PHICH (physical HARQ (hybrid automatic repeat request) indicator channel) or a PDCCH (physical downlink control channel)). A dedicated reference symbol (DRS), defined on antenna port 5, is precoded using a same precoder for data and for data demodulation. It may be noted that dedicated beamforming is UE-specific. That is, beamforming is only applied to resource blocks used for data transmission to the UE.

In downlink signaling, RI (rank indication or rank indicator) denotes the number of data streams to UE in a spatial multiplexing mode. In conventional cellular systems where UE receives data from a single cell, for closed-loop or open-loop spatial multiplexing, RI may be chosen from the set {1, 2, . . . , Nt}, where Nt is the number of cell transmit antennas or antenna ports that is used for dedicated beamforming.

RI can be explicitly signaled in a PDCCH, wherein a total of log₂(Nt) bits is required. RI may also be jointly coded with other information (e.g., a precoding matrix indicator (PMI)) and jointly signaled in a PDCCH. This may be employed in DCI (downlink control information) format 2 for closed-loop spatial multiplexing or DCI format 2A for open-loop spatial multiplexing in E-UTRA, for example.

Beyond LTE Release 8, a performance improvement in throughput is required both in uplink and downlink areas of LTE-Advanced (LTE-A) systems. It is envisioned that advanced dedicated beamforming with support of spatial multiplexing may be applied to LTE-A to further increase the downlink data throughput. As opposed to E-UTRA dedicated beamforming, which only supports a single-layer, rank-1 transmission, LTE-A dedicated beamforming may support multiple data streams in the form of spatial multiplexing to further enhance peak and average sector throughput.

FIG. 1 illustrates a general example of a network MIMO 100 constructed according to the principles of the present disclosure. This arrangement is commonly referred to as a Coordinated Multi-Point (CoMP) communication where multiple transmission points with MIMO capability collaborate in downlink communications. The collection of cells coordinating a CoMP transmission is defined as a super-cell.

The network MIMO 100 includes first and second super cells 105, 110, and first and second user equipment (UE) 115, 120. The first super cell 105 employs a first cluster or set of eNBs (i.e., a super eNB) that includes first, second and third eNBs 106, 107, 108. Correspondingly, the second super cell 110 employs a second set of eNBs or super eNB that includes the first eNB 106 and fourth, fifth and sixth eNBs 111, 112, 113.

As seen in FIG. 1, the number of eNBs associated with each super eNB can be different. Additionally, it is possible to configure the number and indices of eNBs associated with each super eNB based on network topologies, which may include for example, cell size or traffic type (i.e., heavily-loaded cells versus lightly-loaded cells). It may be noted that it is possible to configure only one cell or eNB in each super cell. In this case, the network reverts back to a conventional wireless cellular system, where single-cell communication occurs without cooperation between different cells in a downlink transmission.

The super eNB may be configured to function when the same channel state information is available at each of the individual eNBs, such as through a central controller. Alternatively, the super eNB may be configured to function when channel state information is not generally available at all individual eNBs. In this case, the super eNB functions more like multiple “distributed” eNBs.

The individual eNBs associated with a super eNB may send the same data to a target UE (e.g., the first or second UE 115, 120). Alternatively, different eNBs may send different data to the target UE. In general, there may be some degree of overlap across the data sent from a set of eNBs associated with different cells to the target UE.

Generally, transmissions from the network MIMO super cell corresponds to geographically separated or co-located transmission points. One transmission scenario includes a single cell transmission, where data streams are sent to UE from a single transmission point. This may be contrasted to another transmission scenario of a multiple cell transmission having data streams sent to UE from multiple transmission points. The transmission points may be cells, cell sites, eNBs, distributed antennas or remote radio equipment (RRE).

As a corollary to the two scenarios of single cell and multiple cell transmissions, two issues are addressed to support spatial multiplexing in dedicated beamforming (SMDBF). In DRS design, a dedicated reference symbol structure is required to support data demodulation of multiple streams. This may require additional DRS symbols compared to current rank-1, dedicated beamforming in E-UTRA or redesign of the DRS pattern if the same number of DRS symbols per resource block is to be reserved as in E-UTRA.

For a downlink control channel (called PDCCH for E-UTRA), precoding-related information is signaled via the downlink control channel. This signaling is essential to ensure that a UE knows the number of data streams (denoted by RI) employed in a spatial multiplexing transmission mode for a transmission to UE. Precoding vectors, however, may not need to be explicitly signaled in the PDCCH, since they may be implicitly acquired by estimating the DRS symbols, which are precoded using the same precoding matrices as PDSCH data. It may be noted that signaling of RI in PDCCH is not required in current E-UTRA because the number of layers is always assumed to be one.

FIGS. 2A and 2B illustrate diagrams of a network transmitter 200 as may be employed as a super eNB of a network MIMO super cell, and a network receiver 250 as may be employed by user equipment in the network MIMO super cell. The network transmitter 200 includes a plurality of data buffers 205 corresponding to a plurality of user equipment (UE), a rank control unit 210 and a transmission unit 215 that provides a transmission to a typical UEₖ 220, which is representative of all UEs operating within the network MIMO super cell. The transmission unit 215 includes a set of N super cell transmission points TX₁-TX_{N}, which may be associated with x≦N eNBs. The network receiver 250 includes a reception unit 266 and a rank processing unit 267.

In the illustrated embodiment, the rank control unit 210 provides a rank indication for a dedicated beamforming transmission from the network MIMO super cell, wherein the rank indication corresponds to a spatial multiplexing of multiple data streams for the dedicated beamforming transmission. The transmission unit 215 signals the rank indication to the network receiver 250.

In the illustrated embodiment, the network receiver 250 is employed by the typical UEₖ 220 where the reception unit 266 receives the dedicated beamforming transmission within the network MIMO super cell. The rank processing unit 267 processes the rank indication for the dedicated beamforming transmission, wherein the rank indication corresponds to the spatial multiplexing of the multiple data streams for the dedicated beamforming transmission.

In the illustrated embodiment, each of the super cell transmission points TX₁-TX_{N} may be associated with one cell. A three-cell site, where the cells are formed by sectorization beams, may form a three-cell super cell associated with a single eNB. Alternatively, three single-cell sites may form a three-cell super cell consisting of three eNBs.

Embodiments of this disclosure provide downlink control channel designs supporting RI signaling for SMDFB (spatial multiplexing in dedicated beamforming). It may be noted that if SMDBF is supported in a single-cell transmission, RI is transmitted from the single cell. Although it is possible that RI signaling is transmitted from a different cell than one employing a PDSCH, it is more typical that the RI signaling and PDSCH signaling are transmitted from the same cell.

If SMDBF is supported in a multiple cell CoMP transmission, RIs can be transmitted from a subset or all of the coordinating cells or transmission points and combined at the UE. In this case, it is assumed that the RIs reported from multiple points are identical. Alternatively, RI may be transmitted from a single cell (e.g., an anchor cell to which the UE is synchronized, or the cell with the strongest signal). Embodiments of the present disclosure are applicable to both of these cases wherein RI downlink signaling for SMDBF is addressed first.

In a first approach employing dynamic RI signaling for SMDBF, a RI may be explicitly signaled by an n-bit RI field in a PDCCH to enable UE to receive downlink PDSCH data. Embodiments for this first approach include SMDBF in a single-cell transmission. For example, RI may take a value from {1, 2, . . . , Nt} and a total of log₂(Nt) bits to explicitly signal the RI information in the PDCCH.

Additionally, as opposed to allowing full rank adaptation, it is also possible to configure a rank subset restriction to confine spatial multiplexing beamforming within a specific subset of rank values. In this case, fewer than log₂(Nt) values can be used for RI signaling. For example, instead of allowing full rank adaptation among {1, 2, . . . , Nt} values, higher layer signaling may be applied to restrict spatial multiplexing beamforming over a rank value of {1, . . . , N}, where N<Nt is the maximum rank supported in spatial multiplexing. In this case, log₂(N)<log₂(Nt) bits can be used for explicit RI indication in the PDCCH.

Embodiments for this first approach also include SMDBF in a multiple cell (CoMP) transmission. For example, RI can take a value from {1, 2, . . . , K×Nt}, where K is the number of cells in coordination, and Nt is the number of transmit antennas or antenna ports per cell. Therefore, a total of log₂(KNt) bits are required to explicitly signal the RI information in the PDCCH. This is assuming that the number of UE antennas Nr≧K×Nt is sufficiently large to be able to receive K×Nt data streams. Alternatively, the RI corresponding to different cells can be separately signaled, which requires K log₂(Nt) bits. However, the number of UE receive antennas is typically less than the number of individual cell transmit antennas Nt. In this case, log₂(Nt) bits are sufficient for explicit RI.

Similarly, it is possible to configure a rank subset restriction to confine spatial multiplexing beamforming within a subset of rank values, where the maximum allowed transmission RI may be N for N<KNt. In this case, RI can be signaled with log₂(N) bits. When RI is signaled in a single PDCCH, the single PDCCH may be transmitted from a single transmission point (e.g., a cell), which may be the transmission point with the highest instantaneous or average signal strength, SINR or transmission geometry associated with the UE, for example. Alternatively, the RI may be signaled by a single PDCCH transmitted from multiple transmission points or cells. The size of the PDCCH, when transmitted from multiple transmission points or cells, can be semi-statically configured by a higher layer depending on the number of coordinating cells in the super cell.

Embodiments of the first approach assume fast RI adaptation where an RI change is dynamically performed on a per-subframe basis. This typically necessitates that RI be included in PDCCH signaling. Alternatively, where changes in RI occur more slowly, RI adaptation may also be performed on a semi-static basis thereby allowing RI signaling to be incorporated in other forms of signaling. Furthermore, semi-static configuring of a super eNB may be generally sufficient from the perspective of reducing the signaling overhead and configuration complexity in associated physical layer and backhaul areas.

Therefore, as a second approach, measured or moderate RI adaptation is applicable to SMDBF where downlink RI is performed on a semi-static basis and included in other UE-specific system parameters. For instance, downlink RI may be signaled semi-statically as a part of the RRC message (e.g., RRC signaling that configures UE in a dedicated beamforming mode and concurrently configures a corresponding downlink RI using either log₂(Nt) per cell or log₂(KNt) bits).

Now consider RI in support of higher bandwidth. In a third approach, it is possible to support different downlink transmission ranks in different component carriers for SMDBF. In this approach, the value of RI in different PDCCH or RRC messages associated with different component carriers may be distinct. Here, the component carrier is defined as a spectrum in which UE operates. For an advanced wireless system, such as one conforming to LTE-A Release 10, UE may simultaneously transmit and receive on multiple component carriers that are continuous or non-continuous.

FIG. 3 illustrates a diagram of a 100 MHz bandwidth as may be employed in an LTE-A system. Of course, this can be generalized to any bandwidth or aggregation size. The 100 MHz bandwidth is divided into five component carrier segments of 20 MHz. To support carrier aggregation of these five component carriers, the following data and control signaling structures are considered.

In a first option, independent data and L1/L2 (layer 1/layer 2) control signaling per component carrier is addressed. A medium access control transport block (MAC TB) is divided into five transport blocks, where each is transmitted over a single component carrier. The MAC TB over each component carrier is an independent HARQ entity (with unique HARQ process number, new data indicator (NDI) and redundancy version (RV)), modulation and coding scheme (MCS) and resource assignment fields). It is also possible to assign distinct HARQ entities for different component carriers which have a common MCS. Correspondingly, an L1/L2 control signaling (e.g., PDCCH or ACK/NAK) may be employed for every component carrier.

In a second option, joint data and L1/L2 control signaling are addressed. A single transport block (either MAC layer or physical (PHY) layer) is applied over five component carriers occupying the 100 MHz bandwidth. Correspondingly, a single L1/L2 control signaling entity (e.g., HARQ, PDCCH, ACK/NAK) is applied for the entire 100 MHz bandwidth.

With the first option and since the system bandwidth is fairly large, it is possible for different component carriers to support different transmission ranks in a downlink signal. For example, component carrier 1 may experience deep channel fading and receive a small number of data streams (i.e., a lower rank). Alternately, component carrier 5 may experience small channel fading and receive a large number of data streams (i.e., a higher rank). This is particularly beneficial when non-adjacent component carriers are widely separated in the frequency domain and have different channel characteristics to support multiple streams.

Now consider RI feedback for dedicated beamforming. E-UTRA does not support RI feedback from UE to an eNB because single-layer, rank-1 beamforming is always explicitly assumed. In this case, the UE only reports CQI to the eNB. For a periodic CQI report over a PUCCH (physical uplink control channel), mode 1-0 (wideband CQI) and mode 2-0 (sub-band CQI) are supported. For an aperiodic CQI report over a PUSCH, mode 2-0 and mode 3-0 are supported. However, for SMDBF it is possible to facilitate link adaptation by configuring other modes of RI reporting.

RI reporting for SMDBF may be achieved on a component carrier basis, where different component carriers report a different rank. Alternately, an entire system bandwidth may be employed, where a single RI is reported for the system bandwidth. RI may be separately encoded and reported with CQI (e.g., in a time division multiplexing (TDM) fashion). Alternately, RI may be jointly encoded and reported with CQI. In one case for example, a feedback periodicity of RI reporting may be a multiple of another reporting quantity, such as the periodicity of CQI reporting. Additionally, RI reporting may be achieved on an aperiodic basis.

As an example of RI reporting, assume that an RI equal to three is used in a current downlink data transmission wherein the effective channel from an eNB to a UE is given by a matrix Nr×3 and is known to the UE via channel estimation as expressed in equation (1) below.

$$H = ( \begin{matrix}x & x & x \\ x & x & x \\ x & x & x \\ … & … & … \\ x & x & x\end{matrix} ) \qquad ( 1 )$$

Equation (1) represents the effective channel seen by the UE after dedicated beamforming. Hence, a k^{th} column of H is the channel associated with the k^{th} data stream.

To perform rank adaptation, the UE may calculate the effective channel with a lower RI and report this RI, if better throughput may be obtained. For example, the UE may estimate the downlink throughput using the expression in equation (2).

RI=2:H{(1,2),3)},H{(1,3),2},H{(2,3),1},H{1,2},H{1,3},H{2,3}. (2)

Here, H{(1,2),3} is the channel if the eNB transmits the same data stream over a beamforming vector

$$V = ( \frac{V 1 + V 2}{\sqrt{2}} )$$

and transmits another data stream over another beamforming vector V3. H{1,2} is the channel if the eNB transmits one data stream with beamforming vector V1 and another data stream with beamforming vector V3. If the UE reports an RI equal to two, it may also need to report which two beamforming vectors are to be combined. RI=1:H{(1,2,3)}, H{1}, H{2}, H{3} is the channel if the eNB falls back to a single-rank transmission mode using a beamforming vector 1, vector 2, vector 3 or a vector

$$V = ( \frac{V 1 + V 2 + V 3}{\sqrt{3}} ) .$$

In the examples above, the RI reported by the UE is strictly lower than the current RI in data transmission. It is also possible for the UE to report a higher RI than that used in the current data transmission. Additionally, the UE may report an RI based on a larger scale channel quality indicator (e.g., the Frobenius norm of the channel H, the condition number of H or other similarly appropriate metrics).

FIG. 4 illustrates a flow diagram of an embodiment of a method of operating a network transmitter 400 carried out according to the principles of the present disclosure. The method 400 is for use with a network MIMO super cell and starts in a step 405. Then, in a step 410 a network transmitter is provided and a rank indication is provided for a dedicated beamforming transmission from the network MIMO super cell, wherein the rank indication corresponds to spatial multiplexing of multiple data streams for the dedicated beamforming transmission, in a step 415.

In one embodiment, the rank indication is determined dynamically from a portion of a full rank adaptation for the network MIMO super cell. In another embodiment, the rank indication is determined semi-statically from a portion of the full rank adaptation for the network MIMO super cell. In yet another embodiment, the rank indication is determined independently for each component carrier or jointly for a portion of all component carriers of the dedicated beamforming transmission.

In still another embodiment, the rank indication is separately encoded or jointly encoded with a channel quality indication and reported from user equipment employing rank indication feedback that is a multiple of a period for the channel quality indication or that is triggered on an aperiodic basis.

In a further embodiment, the rank indication is reported from user equipment individually for each component carrier or singularly for a system bandwidth of the dedicated beamforming transmission. The rank indication is signaled in a step 420 and the method 400 ends in a step 425.

FIG. 5 illustrates a flow diagram of an embodiment of a method of operating a network receiver 500 carried out according to the principles of the present disclosure. The method 500 is for use with a network MIMO super cell and starts in a step 505. Then, in a step 510 a network receiver is provided and a dedicated beamforming transmission is received within the network MIMO super cell. A rank indication is processed for the dedicated beamforming transmission, wherein the rank indication corresponds to spatial multiplexing of multiple data streams for the dedicated beamforming transmission, in a step 520.

In one embodiment, the rank indication is determined dynamically from a portion of a full rank adaptation for the network MIMO super cell. In another embodiment, the rank indication is determined semi-statically from a portion of the full rank adaptation for the network MIMO super cell. In yet another embodiment, the rank indication is determined independently for each component carrier or jointly for a portion of all component carriers of the dedicated beamforming transmission.

In still another embodiment, the rank indication is separately encoded or jointly encoded with a channel quality indication and reported from user equipment employing rank indication feedback that is a multiple of a period for the channel quality indication or that is triggered on an aperiodic basis.

In a further embodiment, the rank indication is reported from user equipment individually for each component carrier or singularly for a system bandwidth of the dedicated beamforming transmission. The method 500 ends in a step 525.

While the methods disclosed herein have been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

Those skilled in the art to which this application relates will appreciate that other and further additions, deletions, substitutions and modifications may be made to the described embodiments.

What is claimed is:

1. A network transmitter for use with a network MIMO super cell, comprising:
a rank control unit configured to provide a rank indication for a dedicated beamforming transmission from the network MIMO super cell, wherein the rank indication corresponds to spatial multiplexing of multiple data streams for the dedicated beamforming transmission; and
a transmission unit configured to signal the rank indication.

2. The transmitter as recited in claim 1 wherein the rank indication is determined dynamically or semi-statically from a portion of a full rank adaptation for the network MIMO super cell.

3. The transmitter as recited in claim 1 wherein the rank indication is determined independently for each component carrier or jointly for a portion of all component carriers of the dedicated beamforming transmission.

4. The transmitter as recited in claim 1 wherein the rank indication is separately encoded or jointly encoded with a channel quality indication and reported from user equipment employing rank indication feedback that is a multiple of a period for the channel quality indication or that is triggered on an aperiodic basis.

5. The transmitter as recited in claim 1 wherein the rank indication is reported from user equipment individually for each component carrier or singularly for a system bandwidth of the dedicated beamforming transmission.

6. A method of operating a network transmitter for use with a network MIMO super cell, comprising:
providing a rank indication for a dedicated beamforming transmission from the network MIMO super cell, wherein the rank indication corresponds to spatial multiplexing of multiple data streams for the dedicated beamforming transmission; and
signaling the rank indication.

7. The method as recited in claim 6 wherein the rank indication is determined dynamically or semi-statically from a portion of a full rank adaptation for the network MIMO super cell.

8. The method as recited in claim 6 wherein the rank indication is determined independently for each component carrier or jointly for a portion of all component carriers of the dedicated beamforming transmission.

9. The method as recited in claim 6 wherein the rank indication is separately encoded or jointly encoded with a channel quality indication and reported from user equipment employing rank indication feedback that is a multiple of a period for the channel quality indication or that is triggered on an aperiodic basis.

10. The method as recited in claim 6 wherein the rank indication is reported from user equipment individually for each component carrier or singularly for a system bandwidth of the dedicated beamforming transmission.

11. A network receiver for use with a network MIMO super cell, comprising:
a reception unit configured to receive a dedicated beamforming transmission within the network MIMO super cell; and
a rank processing unit configured to process a rank indication for the dedicated beamforming transmission, wherein the rank indication corresponds to spatial multiplexing of multiple data streams for the dedicated beamforming transmission.

12. The receiver as recited in claim 11 wherein the rank indication is determined dynamically or semi-statically from a portion of a full rank adaptation for the network MIMO super cell.

13. The receiver as recited in claim 11 wherein the rank indication is determined independently for each component carrier or jointly for a portion of all component carriers of the dedicated beamforming transmission.

14. The receiver as recited in claim 11 wherein the rank indication is separately encoded or jointly encoded with a channel quality indication and reported from user equipment employing rank indication feedback that is a multiple of a period for the channel quality indication or that is triggered on an aperiodic basis.

15. The receiver as recited in claim 11 wherein the rank indication is reported from user equipment individually for each component carrier or singularly for a system bandwidth of the dedicated beamforming transmission.

16. A method of operating a network receiver for use with a network MIMO super cell, comprising:
receiving a dedicated beamforming transmission within the network MIMO super cell; and
processing a rank indication for the dedicated beamforming transmission, wherein the rank indication corresponds to spatial multiplexing of multiple data streams for the dedicated beamforming transmission.

17. The method as recited in claim 16 wherein the rank indication is determined dynamically or semi-statically from a portion of a full rank adaptation for the network MIMO super cell.

18. The method as recited in claim 16 wherein the rank indication is determined independently for each component carrier or jointly for a portion of all component carriers of the dedicated beamforming transmission.

19. The method as recited in claim 16 wherein the rank indication is separately encoded or jointly encoded with a channel quality indication and reported from user equipment employing rank indication feedback that is a multiple of a period for the channel quality indication or that is triggered on an aperiodic basis.

20. The method as recited in claim 16 wherein the rank indication is reported from user equipment individually for each component carrier or singularly for a system bandwidth of the dedicated beamforming transmission.
